(19) United States
(12) Patent Application Publication
(10) Pub. No.: US 2010/0047451 A1
(43) Pub. Date: Feb. 25, 2010

(54) ACTINIC-RADIATION CURABLE INK COMPOSITION, INK SET, INK JET PRINTING APPARATUS, AND INK JET RECORDING METHOD USING ACTINIC-RADIATION CURABLE INK COMPOSITION

(75) Inventor: Satoru Miura, Matsumoto-shi (JP)

Correspondence Address: LADAS & PARRY, 26 West 61st Street, New York, NY, 10023, US

(73) Assignee: SEIKO EPSON CORPORATION

(21) Appl. No.: 12/394,534

(22) Filed: Feb. 27, 2009

(30) Foreign Application Priority Data
Feb. 29, 2008 (JP) 2008-051011
Jan. 21, 2009 (JP) 2009-010751

(51) Int. Cl. B05D 5/00; C08F 2/46

(52) U.S. Cl. 427/256; 522/53; 522/26

(57) ABSTRACT

An actinic-radiation curable ink composition includes a colorant, a dendritic polymer serving as a polymerizable compound, and a thioxanthone photoinitiator having a plurality of functional groups. The proportion of the thioxanthone photoinitiator is in the range of 3% to 27% by mass with respect to the total mass of the dendritic polymer.

### BACKGROUND

1. Technical Field

The present invention relates to actinic-radiation curable ink compositions, in particular, an actinic-radiation curable ink composition having excellent curability and abrasion resistance. The invention also relates to an ink set, an ink jet printing apparatus, and ink jet recording method using the actinic-radiation curable ink composition.

2. Related Art

An ink jet recording method is a printing method in which droplets of an ink composition are allowed to fly and deposited on a recording medium such as paper to perform printing. This ink jet recording method is characterized in that images having high resolution and high quality can be formed by printing at high speed. The ink composition used in the ink jet recording method generally contains an aqueous solvent as a main component, a coloring component, and a wetting agent such as glycerin for the purpose of preventing clogging.

In the case where printing is performed on a recording medium formed of, for example, paper or cloth into which an aqueous ink composition does not easily penetrate, or a plate or film composed of a material, such as a metal or plastic material into which the aqueous ink composition does not penetrate, for example, a resin, such as a phenolic, melamine, vinyl chloride, acrylic, or polycarbonate resin, the ink composition is required to contain a component that can allow a colorant to be stably fixed to the recording medium.

For such a requirement, U.S. Pat. No. 5,623,001 discloses a photocurable ink-jet ink containing a colorant, a photocurable material (radically polymerizable compound), and a polymerization initiator (radical photoinitiator). Use of the ink seems to prevent the spread of the ink into the recording medium, improving image quality.

The polymerization initiator needs to sufficiently absorb light having a wavelength emitted from a light source from the viewpoint of improving image quality. For example, JP-A-2007-182535 discloses photocurable ink compositions, i.e., cyan, magenta, yellow, and black inks, each containing the same polymerization initiator in the same amount regardless of the color of the colorant.

Printed matter prepared using the foregoing ink compositions can be placed not only indoors but also outdoors and exposed to sunlight and the air (including ozone, nitrogen oxides, sulfur oxides, etc). Thus, it has been desirable to develop an ink composition having higher lightfastness and gas resistance.

It was found that in the case where the same polymerization initiator was contained in each color ink composition in the same amount when the ink compositions were cured by actinic radiation, however, the amount of light to which the polymerization initiator was exposed was reduced because of the light absorption of the colorants, depending on the colors of the colorants, to reduce the curability of the ink compositions and the abrasion resistance of the printed matter. Significant reductions in the curability of the compositions and the abrasion resistance of the printed matter due to the light absorption of the colorants were observed in the ink compositions each containing a yellow or black colorant.

Meanwhile, in an ink set including the color ink compositions each containing the same polymerization initiator in the same amount, different colors of the colorants result in different rates of a curing reaction. Thus, the ink composition having poor curability should be ejected after the ejection of other compositions.

### SUMMARY

An advantage of some aspects of the invention is that it provides an actinic-radiation curable ink composition having excellent curability, abrasion resistance, and lightfastness and an ink set, an ink jet apparatus, and an ink jet recording method using the actinic-radiation curable ink composition.

(1) According to an aspect of the invention, an actinic-radiation curable ink composition includes a colorant, a dendritic polymer serving as a polymerizable compound, and a thioxanthone photoinitiator having a plurality of functional groups. The proportion of the thioxanthone photoinitiator is in the range of 3% to 27% by mass with respect to the total mass of the dendritic polymer.

(2) It is preferable that the actinic-radiation curable ink composition described in item (1) further include an acylphosphine oxide photoinitiator.

(3) It is preferable that in the actinic-radiation curable ink composition described in item (1), the colorant be a yellow colorant.

(4) It is preferable that in the actinic-radiation curable ink composition described in item (1), the colorant be a black colorant.

(5) An ink set preferably includes the actinic-radiation curable ink composition described in item (1).

(6) An ink jet printing apparatus preferably includes the actinic-radiation curable ink composition described in item (1).

(7) An ink jet recording method preferably uses the actinic-radiation curable ink composition described in item (1).

In the actinic-radiation curable ink composition according to an aspect of the invention, in particular, the ink composition containing the yellow or black colorant is not affected by light absorption of the colorant and thus has excellent curability, thereby providing printed matter having excellent abrasion resistance. Furthermore, the printed matter has excellent lightfastness.

Hitherto, an ink having poor curability has been ejected after the ejection of other inks. In the case of using an ink set including the actinic-radiation curable ink composition according to an aspect of the invention, the order of the ejection of inks can be determined regardless of curability. Furthermore, it is possible to suppress the spread of the inks at overlapping portions due to the different rates of a curing reaction.

### DESCRIPTION OF EXEMPLARY EMBODIMENTS

An actinic-radiation curable ink composition according to an embodiment of the invention will be described in detail below.

The actinic-radiation curable ink composition according to an embodiment of the invention contains a dendritic polymer as a polymerizable compound. Dendritic polymers are broadly classified into six structural groups as described below (see “Dendritic Kobunshi-Tabunkikouzou ga Hirogeru Koukinouka no Sekai-” (“Dendritic Polymers-World of Greater functionality Achieved by Multibranched Structure-”), edited by Keigo AOKI and Masaaki KAKIMOTO, published by NTS Inc).

I Dendrimers

II Linear-dendritic polymers

III Dendrigraft polymers

IV Hyperbranched polymers

V Star-hyperbranched polymers

VI Hypergraft polymers

In Groups I to III, the degree of branching (DB) is 1, and they have defect-free structures. In contrast, in Groups IV to VI, they have random branched structures that may have defects. In particular, dendrimers can have reactive functional groups densely arranged on the outermost surfaces thereof compared with commonly used linear polymers and hold promise as functional polymeric materials. Hyperbranched polymers, dendrigraft polymers, and hypergraft polymers can also have a large number of reactive functional groups on the outermost surfaces thereof, though not to the extent of dendrimers, and excellent curability.

Unlike linear and branched polymers commonly used, these dendritic polymers have three-dimensionally, highly-branched repeat units and thus can have low viscosities compared with linear polymers having the same molecular weight.

Methods for synthesizing dendrimers used in an embodiment of the invention include a divergent method and a convergent method. The divergent method starts with a core molecule and builds outward. The convergent method starts with an outer molecule and builds inward.

Preferably, the dendrimers, hyperbranched polymers, dendrigraft polymers, and hypergraft polymers used in an embodiment of the invention are solid at room temperature and have a number-average molecular weight of 1,000 to 100,000 and particularly preferably 2,000 to 50,000. If these are not solid at room temperature, it is difficult to maintain an image formed. A molecular weight of less than the above range results in a brittle permanent image. A molecular weight exceeding the above range results in ink having an excessively high viscosity even at a lower polymer content, thus leading to impractical flying characteristics.

Furthermore, the dendrimers, hyperbranched polymers, dendrigraft polymers, and hypergraft polymers used in an embodiment of the invention preferably have radically polymerizable functional groups on the outermost surfaces thereof. This structure results in the rapid progress of polymerization reactions.

Examples of the polymers having the dendrimer structures include amidoamine dendrimers (U.S. Pat. Nos. 4,507,466, 4,558,120, 4,568,737, 4,587,329, 4,631,337, and 4,694,064); and phenyl ether dendrimers (U.S. Pat. No. 5,041,516 and Journal of American Chemistry 1990, vol. 112, 7638-7647). With respect to amidoamine dendrimers, a dendrimer having terminal amino groups and methyl carboxylate groups is commercially available as “Starburst™ (PAMAM)” from Sigma-Aldrich Inc. The terminal amino groups of the amidoamine dendrimers are allowed to react with various acrylic acid derivatives and methacrylic acid derivatives to prepare amidoamine dendrimers having corresponding termini, which can be used.

Non-limiting examples of acrylic acid derivatives and methacrylic acid derivatives that can be used include alkyl (meth)acrylates, where alkyl represents methyl, ethyl, n-butyl, tert-butyl, cyclohexyl, palmityl, stearyl, or the like; and (meth)acrylamides such as N-isopropyl(meth)acrylamide.

Various phenyl ether dendrimers are described in Journal of American Chemistry 1990, vol. 112, 7638-7647 described above. For example, 3,5-dihydroxybenzyl alcohol is reacted with 3,5-diphenoxybenzyl bromide to form second-generation benzyl alcohol. The OH group is converted into Br using CBr₄ and triphenylphosphine. The resulting compound is similarly reacted with 3,5-dihydroxybenzyl alcohol to prepare next-generation benzyl alcohol. The above reactions are repeated to yield a target dendrimer. The terminal benzyl ether linkages of the phenyl ether dendrimers can also be replaced with moieties having various chemical structures. For example, in the synthesis of the dendrimers described in Journal of American Chemistry 1990, vol. 112, 7638-7647 described above, the use of various alkyl halide in place of the foregoing benzyl bromide results in phenyl ether dendrimers with terminal structures having corresponding alkyl groups. In addition, polyamine dendrimer (Macromol. Symp. 77, 21 (1994)) and its derivatives having modified terminal groups can be used.

As the hyperbranched polymers, for example, hyperbranched poly(ethylene glycol)s and the like can be used. Each of the hyperbranched polymers is synthesized in one step with a monomer having two or more reactive sites corresponding to branch points and another single reactive site corresponding to a connecting point in its molecule (Macromolecules 1996, vol. 29, pp. 3831-3838). Examples of the monomer used for the synthesis of hyperbranched polymers include 3,5-dihydroxybenzoic acid derivatives. An example of the production of the hyperbranched polymer is described below. Methyl 3,5-bis((8′-hydroxy-3′,6′-dioxaoctyl)oxy)benzoate, which is a hydrolysate of methyl 3,5-bis{[8′-(tert-butyldiphenylsiloxy)-3′,6′-dioxaoctyl]oxy}benzoate prepared from 1-bromo-8-(tert-butyldiphenylsiloxy)-3,6-dioxaoctane and methyl 3,5-dihydroxybenzoate, is heated in the presence of dibutyltin diacetate in a nitrogen atmosphere to yield poly[bis(triethylene glycol) benzoate] as a hyperbranched polymer.

In the case of using 3,5-dihydroxybenzoic acid, the resulting hyperbranched polymer has terminal hydroxy groups. In this case, hyperbranched polymers having various terminal groups can be synthesized by reacting the hydroxy groups with appropriate alkyl halides.

Characteristics of monodisperse polymers having dendrimer structures, hyperbranched polymers, and the like are governed by chemical structures of main chains and their terminal groups. In particular, different terminal groups and different substituents in the chemical structures result in significantly different characteristics. The polymers with polymerizable groups at their terminals have high gelation effects owing to their reactivity after photoreactions and are thus useful. The polymerizable group-containing dendrimers are prepared by chemically modifying terminals of dendrimers having basic atomic groups, such as amino, substituted amino, and hydroxy groups, at their terminals, with polymerizable group-containing compounds.

For example, a polymerizable group-containing dendrimer is synthesized by adding an isocyanate group-containing vinyl compound to a polyfunctional compound prepared by Michael addition of an active hydrogen-containing (meth)acrylate compound to an amine dendrimer. In addition, for example, a dendrimer having polymerizable groups at its terminals is synthesized by reacting an amine dendrimer with (meth)acryloyl chloride. Examples of the vinyl compound that can give the polymerizable group include radically polymerizable compounds having ethylenically unsaturated bonds. Examples thereof include unsaturated carboxylic acids, such as acrylic acid, methacrylic acid, itaconic acid, crotonic acid, isocrotonic acid, and maleic acid, and salts thereof; and various radically polymerizable compounds having ethylenically unsaturated bonds.

In accordance with an embodiment of the invention, the foregoing dendrimers, hyperbranched polymers, dendrigraft polymers, and hypergraft polymers may be used separately or in combination with other types of dendrimers and hyperbranched polymers.

The actinic-radiation curable ink composition according to an embodiment of the invention preferably has a dendritic polymer content of about 3% to about 30% by mass and can maintain suitable properties as an actinic-radiation curable ink composition. More preferably, the dendritic polymer content is in the range of about 5% to about 25% by mass.

A dendritic polymer content of less than 3% by mass results in an actinic-radiation curable ink composition having insufficient curability. A dendritic polymer content exceeding 30% by mass may result in an ink composition having inappropriate viscosity, dispersion stability, storage stability, and the like.

The actinic-radiation curable ink composition according to an embodiment of the invention contains the foregoing dendritic polymer and preferably allyl glycol and/or N-vinylformamide as a diluent monomer and a photoinitiator.

Each of allyl glycol and N-vinylformamide is a monofunctional radically polymerizable monomer. The possibility that these compounds react with the photoinitiator to cause undesirable polymerization during storage is low, which is suitable.

The composition containing less than 20% by mass allyl glycol and/or N-vinylformamide has inappropriate viscosity, dispersion stability, storage stability, and the like. The composition containing more than 80% by mass allyl glycol and/or N-vinylformamide may have insufficient curability. More preferably, the proportion of allyl glycol and/or N-vinylformamide is in the range of about 20% to about 70% by mass.

The actinic-radiation curable ink composition according to an embodiment of the invention contains allyl glycol and/or N-vinylformamide as a diluent monomer and may further contain another polymerizable compound.

Non-limiting examples of another polymerizable compound include monomers.

The term “monomers” is used to indicate molecules that can form constitutional units of basic structures of polymers. Examples of the monomers that can be used in an embodiment of the invention include monofunctional monomers, bifunctional monomers, and polyfunctional monomers. In view of safety, any of the monomers preferably has a primary irritation index (PII) of 2 or less.

Table 1 shows examples of the monofunctional, bifunctional, and polyfunctional monomers having a PII value of 2 or less and usable in an embodiment of the invention.

TABLE 1

| | Viscosity | |
|---|---|---|
| | (mPa · s) | PII |
| Monofunctional monomer Compound | | |
| (2-Methyl-2-ethyl-1,3-dioxolan-4-yl)methyl acrylate (MEDOL-10, Osaka Organic Chemical Industry Ltd.) | 5.1 | 1.3 |
| (2-Methyl-2-isobutyl-1,3-dioxolan-4-yl)methyl acrylate (MIBDOL-10, Osaka Organic Chemical Industry Ltd.) | 5.3 | 1.0 |
| Phenoxyethyl acrylate (Viscoat #192, Osaka Organic Chemical Industry Ltd.) | 3.3 | 1.7 |
| Isobornyl acrylate (IBXA, Osaka Organic Chemical Industry Ltd.) | 2.6 | 0.6 |
| Methoxy diethylene glycol monoacrylate (BLEMMER PME-100, NOF Corporation) | 2 | 0.7 |
| Acryloylmorpholine (ACMO, KOHJIN Co., Ltd.) | 12 | 0.5 |
| Bifunctional monomer Compound | | |
| Ethylene glycol dimethacrylate (LIGHT-ESTER EG, Kyoeisya Chemical Co., Ltd.) | 3 | 0.6 |
| Diethylene glycol dimethacrylate (LIGHT-ESTER 2EG, Kyoeisya Chemical Co., Ltd.) | 5 | 0.5 |
| Tripropylene glycol diacrylate (Aronix M-220, Toagosei Co., Ltd.) | 12 | 1.6 |
| 1,9-Nonanediol diacrylate (Viscoat #192, Osaka Organic Chemical Industry Ltd.) | 21 | 2.0 |
| Polyethylene glycol #400 diacrylate (NK ESTER A400, Shin-Nakamura Chemical Co., Ltd.) | 58 | 0.4 |
| Polyethylene glycol 200 dimethacrylate (NK ESTER 4G, Shin-Nakamura Chemical Co., Ltd.) | 14 | 0.5 |
| 1,6-Hexanediol dimethacrylate (NK ESTER HD-N, Shin-Nakamura Chemical Co., Ltd.) | 6 | 0.5 |
| Neopentyl glycol dimethacrylate (NK ESTER NPG, Shin-Nakamura Chemical Co., Ltd.) | 7 | 0.0 |
| 2-Hydroxy-1,3-dimethacryloxypropane (NK ESTER 701, Shin-Nakamura Chemical Co., Ltd.) | 37 | 0.6 |
| Polyfunctional monomer Compound | | |
| Trimethylolpropane trimethacrylate (NK ESTER TMPT, Shin-Nakamura Chemical Co., Ltd.) | 42 | 0.8 |
| Trimethylolpropane-modified triacrylate (Viscoat #360, Osaka Organic Chemical Industry Ltd.) | 55 | 1.5 |
| Trimethylolpropane PO-modified triacrylate (NEW FRONTIER TMP-3P, Dai-ichi Kogyo Seiyaku Co., Ltd.) | 60 | 0.1 |
| Glycerol PO-modified triacrylate (Viscoat #GPT, Osaka Organic Chemical Industry Ltd.) | 75 | 0.8 |

The viscosities shown in Table 1 are measurements at 25° C.

The actinic-radiation curable ink composition according to an embodiment of the invention may further contain an oligomer in addition to the monomer described above.

The actinic-radiation curable ink composition according to an embodiment of the invention contains a thioxanthone polymerization initiator having a plurality of functional groups, as a photoinitiator.

Examples of the thioxanthone polymerization initiator having the plurality of functional groups include 2,4-diethylthioxanthone, 2,4-diisopropylthioxanthone, 2,4-dimethylthioxanthone, and 2,4-dichloromethylthioxanthone. An ethyl group-containing thioxanthone polymerization initiator is preferred. In particular, 2,4-diethylthioxanthone is preferred.

The composition contains 3% to 27% by mass, preferably 3% to 8% by mass, more preferably 3% to 7% by mass, and particularly preferably 4% to 7% by mass of the thioxanthone polymerization initiator having the plurality of functional groups with respect to the dendritic polymer.

A proportion of the thioxanthone polymerization initiator having the plurality of functional groups of less than 3% by mass results in insufficient curability and abrasion resistance. A proportion of the initiator of more than 27% by mass is liable to cause shrinkage during curing to detach a film from a medium. In the case where the proportion of the thioxanthone polymerization initiator having the plurality of functional groups is in the above range, the composition also has excellent lightfastness. The reason for this may be as follows: A cured film having excellent surface smoothness is formed and does not readily absorb light, thereby reducing the amount of energy delivered to the colorant in the cured film, so that the color is not readily degraded.

The actinic-radiation curable ink composition according to an embodiment of the invention may contain a photoinitiator other than those described above. Non-limiting examples of the photoinitiator include benzil dimethyl ketal, α-hydroxyalkylphenone, α-aminoalkylphenone, acylphosphine oxide, oxime ester, α-dicarbonyl, and anthraquinone. From the viewpoints of achieving good compatibility with a photopolymerizable oligomer and a diluent, curability in a thick film containing pigments, and curing by hydrogen abstraction, acylphosphine oxide is preferably used in combination with the foregoing photoinitiator.

The foregoing photoinitiators are available under the trade names of Vicure 10 and 30 (manufactured by Stauffer Chemical Co.), Irgacure 127, 184, 500, 651, 2959, 907, 369, 379, 754, 1700, 1800, 1850, 819, OXE 01, Darocur 1173, TPO, and ITX (manufactured by Ciba Specialty Chemicals Inc.), Quantacure CTX (manufactured by Aceto Chemical Co.), and ESACURE KIP150 (manufactured by Lamberti S.p.A).

The actinic-radiation curable ink composition according to an embodiment of the invention may contain a polymerization promoter.

Non-limiting examples of the polymerization promoter include Darocur EHA and EDB (manufactured by Ciba Specialty Chemicals Inc).

Furthermore, the actinic-radiation curable ink composition according to an embodiment of the invention preferably contains an inhibitor of thermal radical polymerization, thereby improving the storage stability of the ink composition. An example of the inhibitor of thermal radical polymerization is Irgastab V-10 (manufactured by Ciba Specialty Chemicals Inc).

The actinic-radiation curable ink composition according to an embodiment of the invention may further contain a surfactant. For example, a polyester-modified silicone or polyether-modified silicone is preferably used as a silicone surfactant. A polyether-modified polydimethylsiloxane or a polyester-modified polydimethylsiloxane is particularly preferably used. Specific examples thereof include BYK-347, BYK-348, BYK-UV3500, 3510, 3530, and 3570 (manufactured by BYK Japan KK).

The actinic-radiation curable ink composition according to an embodiment of the invention contains a colorant.

In this case, the colorant may be a dye or pigment. The pigment, however, has an advantage in the durability of printed matter.

Examples of the dye that can be used in an embodiment of the invention include various dyes commonly used for ink jet recording, e.g., direct dyes, acid dyes, food colors, basic dyes, reactive dyes, disperse dyes, vat dyes, soluble vat dyes, and reactive disperse dyes.

Inorganic pigments and organic pigments can be used in an embodiment of the invention without particular limitation.

Examples of the inorganic pigments that can be used include carbon blacks produced by known processes, such as a contact process, a furnace process, and a thermal process; titanium oxide; and iron oxide. Examples of the organic pigments that can be used include azo pigments, such as azo lake pigments, insoluble azo pigments, condensed azo pigments, and chelate azo pigments; polycyclic pigments, such as phthalocyanine pigments, perylene pigments, perinone pigments, anthraquinone pigments, quinacridone pigments, dioxazine pigments, thioindigo pigments, isoindolinone pigments, and quinophthalone pigments); dye chelates, such as basic dye chelates and acid dye chelates; nitro pigments; nitroso pigments; and aniline black.

Specific examples of carbon blacks include C.I. Pigment Black 7; No. 2300, No. 900, MCF88, No. 33, No. 40, No. 45, No. 52, MA7, MA8, MA100, and No. 2200B manufactured by Mitsubishi Chemical Corporation; Raven 5750, Raven 5250, Raven 5000, Raven 3500, Raven 1255, and Raven 700 manufactured by Columbia Co.; Regal 400R, Regal 330R, Regal 660R, Mogul L, Mogul 700, Monarch 800, Monarch 880, Monarch 900, Monarch 1000, Monarch 1100, Monarch 1300, and Monarch 1400 manufactured by Cabot Co.; and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 manufactured by Degussa Co.

Examples of the pigment for use in a yellow ink include C.I. Pigment Yellow 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213.

Examples of the pigment for use in a magenta ink include C.I. Pigment Red 5, 7, 12, 48 (Ca), 48 (Mn), 57 (Ca), 57:1, 112, 122, 123, 168, 184, 202, 209, and C.I. Pigment Violet 19.

Examples of the pigment for use in a cyan ink include C.I. Pigment Blue 1, 2, 3, 15:3, 15:4, 60, 16, and 22.

According to a preferred embodiment of the invention, the pigment preferably has an average particle size of 10 to 200 nm and more preferably about 50 to 150 nm.

The actinic-radiation curable ink composition according to an embodiment of the invention preferably has a colorant content of about 0.1% to about 25% by mass and more preferably about 0.5% to about 15% by mass.

According to a preferred embodiment of the invention, each of the pigments can be dispersed in an aqueous medium in the presence of a dispersant or surfactant to form a pigment dispersion for the ink composition. Preferred examples of the dispersant that can be used include dispersants commonly used to prepare pigment dispersions, e.g., polymeric dispersants.

In the case where the ink compositions contain colorants, an ink set may include a plurality of ink compositions for each color. For example, in the case where a dark color and a light color of a similar color are used for each color in addition to the basic four colors of yellow, magenta, cyan, and black, the ink set may include light magenta as a light color and red as a dark color in addition to magenta, light cyan as a light color and blue as a dark color in addition to cyan, and gray and light black as light colors and mat black as a dark color in addition to black.

The actinic-radiation curable ink composition according to an embodiment of the invention may further contain common additional components, for example, a humectant, a penetrant, a pH adjuster, a preservative, and a fungicide, that can be used in actinic-radiation curable ink.

In addition, a leveling additive, a matte agent, a polyester resin, a polyurethane resin, a vinyl resin, an acrylic resin, a rubber resin, or wax, which are used for adjusting film properties, may be added as needed.

In the case where the actinic-radiation curable ink composition according to an embodiment of the invention is used in an ink jet recording method, each ink composition preferably has a viscosity of 10 mpa·s or less at 25° C. in view of operation.

An ink jet recording method using the actinic-radiation curable ink composition according to an embodiment of the invention includes ejecting the ink composition on a recording medium and then performing irradiation with actinic radiation such as ultraviolet rays.

Examples of the actinic radiation include ultraviolet rays, near-ultraviolet rays, and natural light (including filtered light). Ultraviolet rays are preferred. An irradiation light source is not particularly limited.

Light emitted from the light source is preferably in the range of 350 nm to 450 nm.

In the case of using ultraviolet rays as the actinic radiation, the ultraviolet dose is in the range of 10 mJ/cm² to 20,000 mJ/cm² and preferably 50 mJ/cm² to 15,000 mJ/cm². When the ultraviolet dose is within the above range, the curing reaction can be successfully performed.

Ultraviolet irradiation can be performed with a lamp, e.g., an ultraviolet-light-emitting diode (Ultraviolet LED), a metal halide lamp, a xenon lamp, a carbon arc lamp, a chemical lamp, a low-pressure mercury lamp, or a high-pressure mercury lamp. For example, a commercially available lamps, such as H Lamp, D Lamp, and V Lamp manufactured by Fusion System, may be used.

Furthermore, the ultraviolet irradiation can be performed with an ultraviolet-light-emitting semiconductor element such as an ultraviolet-light-emitting semiconductor laser.

The actinic-radiation curable ink composition according to an embodiment of the invention can be applied by printing with a known ink jet printing apparatus.

### EXAMPLES

While the invention will be described in detail by means of examples, the invention is not limited thereto.

### Examples 1 to 12 and Comparative Examples 1 to 8

### Preparation of Actinic-Radiation Curable Ink Composition

Allyl glycol was used as a polymerizable compound. Viscoat #1000 (manufactured by Osaka Organic Chemical Industry Ltd.) was used as a radically polymerizable compound (hyperbranched polymer). Viscoat #1000 contains a hyperbranched polymer having a dipentaerythritol core and branched functional groups and ethylene glycol diacrylate serving as a diluent monomer and has a viscosity of 273 mPa·s. The hyperbranched polymer has 14 functional groups (acrylic groups). Viscoat #1000 has acryloyl groups at the outermost layer and thus can be suitably used.

Dendrimers are highly stereoregular and require a large number of production steps, increasing the cost. Hyperbranched polymers have relatively high stereoregularity and are relatively simply synthesized, providing a cost advantage.

A pigment dispersion was prepared by a method described below.

Allyl glycol (manufactured by Nippon Nyukazai Co., Ltd.) as a monomer was added to 15 parts by mass of C.I. Pigment Black 7 (carbon black) serving as a colorant and 3.5 parts by mass of Discoall N-509 (manufactured by Dainichiseika Color & Chemicals Mfg. Co., Ltd.) as a dispersant in such a manner that the mixture was 100 parts by mass, followed by stirring and mixing. The resulting mixture was subjected to dispersing treatment for 6 hours together with zirconia beads (diameter: 1.5 mm) using a sand mill (manufactured by Yasukawa Seisakusho KK).

Then, the zirconia beads were separated with a separator to provide a black pigment dispersion.

A yellow pigment dispersion (C.I. Pigment Yellow 155) was similarly prepared.

The hyperbranched polymer, the pigment dispersions, allyl glycol, polymerization initiators, a polymerization modifier, and an inhibitor of thermal radical polymerization were mixed so as to achieve the compositions (percent by mass) shown in Table 2, thereby preparing actinic-radiation curable ink compositions of Examples 1 to 12 and Comparative Examples 1 to 8.

The initiators shown in Table 2 are described below.

Irgacure 819: Acylphosphine oxide initiator

Irgacure 127: Alkylphenone initiator

Kayacure DETX-S: 2,4-Diethylthioxanthone

DOROCURE ITX: Isopropylthioxanthone

TABLE 2

| | | Example 1 | Example 2 | Example 3 | Example 4 | Example 5 | Example 6 | Example 7 | Example 8 |
|---|---|---|---|---|---|---|---|---|---|
| | | Bk | Y | Bk | Y | Bk | Y | Bk | Y |
| Allyl glycol | Monomer | 73.85 | 73.85 | 73.55 | 73.55 | 73.1 | 73.1 | 70.2 | 70.2 |
| Viscoat #1000 | Oligomer | 15 | 15 | 15 | 15 | 15 | 15 | 15 | 15 |
| irgacure819 | Initiator | 5.8 | 5.8 | 5.8 | 5.8 | 5.8 | 5.8 | 5.9 | 5.9 |
| irgacure127 | Initiator | 1.6 | 1.6 | 1.6 | 1.6 | 1.6 | 1.6 | 1.6 | 1.6 |
| Kayacure DETX-S | Initiator | 0.45 | 0.45 | 0.75 | 0.75 | 1.2 | 1.2 | 4.0 | 4.0 |
| DOROCURE ITX | Initiator | — | — | — | — | — | — | — | — |
| BYK-UV3570 | Modifier | 0.1 | 0.1 | 0.1 | 0.1 | 0.1 | 0.1 | 0.1 | 0.1 |
| irgastab UV10 | Inhibitor | 0.2 | 0.2 | 0.2 | 0.2 | 0.2 | 0.2 | 0.2 | 0.2 |
| pigment Black-7 | Pigment | 3 | — | 3 | — | 3 | — | 3 | — |
| pigment yellow 155 | Pigment | — | 3 | — | 3 | — | 3 | — | 3 |
| DETX-S/Viscoat #1000 | | 0.03 | 0.03 | 0.05 | 0.05 | 0.08 | 0.08 | 0.27 | 0.27 |
| (mass ratio) | | | | | | | | | |

| | | | Example | Example | Example |
|---|---|---|---|---|---|
| | | Example 9 | 10 | 11 | 12 |
| | | Bk | Y | Bk | Y |
| Allyl glycol | Monomer | 73.85 | 73.85 | 70.2 | 70.2 |
| Viscoat #1000 | Oligomer | 15 | 15 | 15 | 15 |
| irgacure819 | Initiator | 5.8 | 5.8 | 5.9 | 5.9 |
| irgacure127 | Initiator | 1.6 | 1.6 | 1.6 | 1.6 |
| Kayacure DETX-S | Initiator | — | — | — | — |
| DOROCURE ITX | Initiator | — | — | — | — |
| 2,4-Dipropylthioxanthone | Initiator | 0.45 | 0.45 | 4.0 | 4.0 |
| BYK-UV3570 | Modifier | 0.1 | 0.1 | 0.1 | 0.1 |
| irgastab UV10 | Inhibitor | 0.2 | 0.2 | 0.2 | 0.2 |
| pigment Black-7 | Pigment | 3 | — | 3 | — |
| pigment yellow 155 | Pigment | — | 3 | — | 3 |
| DETX-S/Viscoat #1000 | | 0.03 | 0.03 | 0.27 | 0.27 |
| (mass ratio) | | | | | |

| | | | | | | Com- | Com- | Com- | Com- |
|---|---|---|---|---|---|---|---|---|---|
| | | Comparative | Comparative | Comparative | Comparative | parative | parative | parative | parative |
| | | Example 1 | Example 2 | Example 3 | Example 4 | Example 5 | Example 6 | Example 7 | Example 8 |
| | | Bk | Y | Bk | Y | Bk | Y | Bk | Y |
| Allyl glycol | Monomer | 74.2 | 74.2 | 73.75 | 73.75 | 74 | 74 | 70.1 | 70.1 |
| Viscoat | Oligomer | 15 | 15 | 15 | 15 | 15 | 15 | 15 | 15 |
| #1000 | | | | | | | | | |
| irgacure819 | Initiator | 5.9 | 5.9 | 5.9 | 5.9 | 5.8 | 5.8 | 5.8 | 5.8 |
| irgacure127 | Initiator | 1.6 | 1.6 | 1.6 | 1.6 | 1.6 | 1.6 | 1.6 | 1.6 |
| Kayacure | Initiator | — | — | — | — | 0.3 | 0.3 | 4.2 | 4.2 |
| DETX-S | | | | | | | | | |
| DOROCURE | Initiator | — | — | 0.45 | 0.45 | — | — | — | — |
| ITX | | | | | | | | | |
| BYK- | Modifier | 0.1 | 0.1 | 0.1 | 0.1 | 0.1 | 0.1 | 0.1 | 0.1 |
| UV3570 | | | | | | | | | |
| irgastab | Inhibitor | 0.2 | 0.2 | 0.2 | 0.2 | 0.2 | 0.2 | 0.2 | 0.2 |
| UV10 | | | | | | | | | |
| pigment | Pigment | 3 | — | 3 | — | 3 | — | 3 | — |
| Black-7 | | | | | | | | | |
| pigment | Pigment | — | 3 | — | 3 | — | 3 | — | 3 |
| yellow 155 | | | | | | | | | |
| DETX- | | — | — | — | — | 0.02 | 0.02 | 0.28 | 0.28 |
| S/Viscoat | | | | | | | | | |
| #1000 | | | | | | | | | |
| (mass ratio) | | | | | | | | | |

### Curability Test

Each of the inks prepared in Examples 1 to 12 and Comparative Examples 1 to 8 was mounted on a printing apparatus provided with an ink jet head. The mass of the each ink was adjusted in such a manner that the amount of the ink ejected during printing was 5 to 5.5 ng. About 1,030,000 dots of droplets for each ink were placed in a one-inch square area and then irradiated with light having a wavelength of 365 to 400 nm and a power of 1 to 150 mW. Comparisons were made among the amounts of light energy required to allow the resulting areas to be dry to the touch. Table 3 shows the results.

Energy requirement of less than 250 mJ/cm²: Excellent

Energy requirement of 250 to 350 mJ/cm²: Good

Energy requirement exceeding 350 mJ/cm²: Fair

### Abrasion Resistance

An abrasion test according to JIS K 5701 was performed with a Japan Society for the Promotion of Science-type color fastness rubbing tester (manufactured by Tester Sangyo Co., Ltd). The test method is as follows: Shirtings were placed on surfaces of printed articles. Each of the printed articles was rubbed under a load of 500 g. After rubbing, the detachment of cured compositions arranged on the surfaces of the printed articles was visually checked. Table 3 shows the results.

The shirting was not smudged, and the solid pattern was not detached: Excellent

The shirting was smudged, and the solid pattern was not detached: Good

The shirting was smudged, and the solid pattern was linearly detached: Fair

The shirting was smudged, and the solid pattern was detached in the form of a plane: Poor

### Lightfastness Test

The printed articles were exposed to light at 70,000 lux for 14 weeks with a Xenon weathermeter (model XL-75, manufactured by Suga Test Instruments Co., Ltd.). The values of L*a*b* before and after exposure were measured with a colorimeter (Spectrolino, manufactured by Gretag-Macbeth AG), and the change in L*a*b* values was determined. Table 3 shows the results.

ΔE was 0 or more and less than 0.5: Excellent

ΔE was 0.5 to 1.0: Good

ΔE was more than 1.0: Fair

### Ink Viscosity

The viscosity of the ink was measured with an E-type viscometer (EMD-type cone-and-plate rotary viscometer, manufactured by Tokyo Keiki Inc) at 20° C. Table 3 shows the results. An ink viscosity of 17 mpa·s or less results in satisfactory ejection properties.

TABLE 3

| | | Exam- | Exam- | Exam- | Exam- | Exam- | Exam- | Exam- | Exam- | Exam- | Example | Example | Example |
|---|---|---|---|---|---|---|---|---|---|---|---|---|---|
| | Evaluation item | ple 1 | ple 2 | ple 3 | ple 4 | ple 5 | ple 6 | ple 7 | ple 8 | ple 9 | 10 | 11 | 12 |
| Evaluation | Curability | Ex- | Ex- | Ex- | Ex- | Ex- | Ex- | Ex- | Ex- | Ex- | Excellent | Excellent | Excellent |
| | | cellent | cellent | cellent | cellent | cellent | cellent | cellent | cellent | cellent | | | |
| | Abrasion | Ex- | Ex- | Ex- | Ex- | Ex- | Ex- | Ex- | Ex- | Ex- | Excellent | Excellent | Excellent |
| | resistance | cellent | cellent | cellent | cellent | cellent | cellent | cellent | cellent | cellent | | | |
| | Lightfastness | Ex- | Ex- | Ex- | Ex- | Ex- | Ex- | Ex- | Ex- | Ex- | Excellent | Excellent | Excellent |
| | | cellent | cellent | cellent | cellent | cellent | cellent | cellent | cellent | cellent | | | |
| | Ink viscosity | 12.3 | 11.3 | 12.7 | 11.8 | 13.2 | 12.3 | 14.1 | 14.6 | 11.8 | 12.3 | 14.7 | 14.8 |
| | (mPa · s) | | | | | | | | | | | | |

| | | Comparative | Comparative | Comparative | Comparative | Comparative | Comparative | Comparative | Comparative |
|---|---|---|---|---|---|---|---|---|---|
| | Evaluation item | Example 1 | Example 2 | Example 3 | Example 4 | Example 5 | Example 6 | Example 7 | Example 8 |
| Evaluation | Curability | Fair | Fair | Good | Good | Fair | Fair | Good | Good |
| | Abrasion resistance | Good | Good | Good | Good | Good | Good | Good | Good |
| | Lightfastness | Good | Good | Good | Good | Good | Good | Fair | Fair |
| | Ink viscosity | 11.9 | 11.1 | 11.6 | 11.3 | 11.3 | 10.9 | 13.8 | 14.2 |
| | (mPa · s) | | | | | | | | |

These results demonstrated that the actinic-radiation curable ink compositions according to Examples of the invention provided printed matter having excellent curability and abrasion resistance compared with Comparative Examples.

Furthermore, the actinic-radiation curable ink compositions according to Examples had excellent lightfastness.

What is claimed is:

1. An actinic-radiation curable ink composition comprising:
a colorant;
a dendritic polymer serving as a polymerizable compound; and
a thioxanthone photoinitiator having a plurality of functional groups,
wherein the proportion of the thioxanthone photoinitiator is in the range of 3% to 27% by mass with respect to the total mass of the dendritic polymer.

2. The actinic-radiation curable ink composition according to claim 1, further comprising:
an acylphosphine oxide photoinitiator.

3. The actinic-radiation curable ink composition according to claim 1, wherein the colorant is a yellow colorant.

4. The actinic-radiation curable ink composition according to claim 1, wherein the colorant is a black colorant.

5. An ink set comprising:
the actinic-radiation curable ink composition according to claim 1.

6. An ink jet printing apparatus comprising:
the actinic-radiation curable ink composition according to claim 1.

7. An ink jet recording method using the actinic-radiation curable ink composition according to claim 1.
